(19) United States
(12) Patent Application Publication
(10) Pub. No.: US 2022/0185557 A1
(43) Pub. Date: Jun. 16, 2022

(54) ROCK BAG

(71) Applicant: BIN LEONG CHUA, Singapore (SG)

(72) Inventor: BIN LEONG CHUA, Singapore (SG)

(21) Appl. No.: 17/547,313

(22) Filed: Dec. 10, 2021

Related U.S. Application Data
(60) Provisional application No. 63/124,189, filed on Dec. 11, 2020.

(51) Int. Cl. B65D 65/42; B65D 33/08; B65D 33/12; B65D 30/20; B65D 30/08; B29D 22/00; B31B 70/74

(52) U.S. Cl. CPC B65D 65/42; B65D 33/08; B65D 33/12; B29K 2509/14; B65D 31/02; B29D 22/003; B31B 70/74; B65D 31/10

(57) ABSTRACT

A rock bag and method of manufacturing same are provided herein. In one embodiment, the rock bag has a first set of opposed sides, each side of which is substantially the same dimensions, a second set of opposed sides, each side of which is substantially the same dimensions, and a bottom side formed to operatively couple with the first and second set of opposed sides such that the rock bag forms an enclosure with five sides and an opening opposite the bottom side. And the material forming the sides comprises between 40% and 90% rock content.

### CROSS-REFERENCE TO RELATED APPLICATIONS

The present disclosure claims the benefit of Provisional Patent Application No. 63/124,189, titled “Rock Bag,” filed on Dec. 11, 2020, the entire subject matter and contents thereof are incorporated herein by reference.

### DESCRIPTION OF THE INVENTION

### Field of the Invention

This application relates to rock bags, and methods of manufacture thereof. In one embodiment, it pertains to rock bags substantially comprising plastic and rock and/or another material with a high calcium carbonate content, such as, but not limited to limestone and shells.

### BACKGROUND OF THE INVENTION

The use of rock and/or calcium carbonate content in addition to plastics in the manufacture of disposable and/or other bags may be environmentally and economically advantageous. For example, limestone and crushed shells are a widely available, environmentally friendly, and cheap resources. The inclusion of such materials in manufacturing bags may reduce the amount of plastic needed in manufacturing.

Presently, the main alternative to disposable plastic bags is paper bags. Many consumers like the feel of paper bags as opposed to plastic. However, paper bags are often substantially less durable and/or weaker than plastic bags. Furthermore, paper bag manufacturing consumes limited wood resources, and the processing of wood into paper pulp has deleterious environmental effects.

While disposable bags made of plastic and rock materials exist, they are substantially limited to 20%-30% rock and/or calcium carbonate content by weight. It is believed that this is because calcium carbonate tends to absorb moisture and, accordingly, a bag with rock and/or calcium carbonate content above 30%, 40%, and/or 50% and manufactured with existing techniques may be insufficiently strong, insufficiently, flexible, or otherwise be an unsuitable substitute for plastic or paper bags from the viewpoint of the consumer.

It is accordingly a primary object of the invention to manufacture bags with reduced plastic content, no or limited paper content, suitable durability and strength, and/or qualities similar to those of paper bags.

### SUMMARY OF THE INVENTION

In accordance with an embodiment of the invention, a rock bag comprises a first set of opposed sides, each side of which is substantially the same dimensions; a second set of opposed sides, each side of which is substantially the same dimensions; a bottom side formed to operatively couple with the first and second set of opposed sides such that the rock bag forms an enclosure with five sides and an opening opposite the bottom side; wherein the material forming the sides comprises between 40% and 90% rock content.

In another embodiment, a method of manufacturing a rock bag comprises the steps of forming crushed rock material into one or more pellets, combining the one or more pellets with additional materials, heating the combined materials to approximately 180-200° C., mixing the heated pellets and the additional materials to obtain a uniform rock-plastic mixture, forming the rock-plastic mixture into a sheet, and repeating steps a-e to obtain multiple sheets that are then rolled into one or more rolls of reel for forming one or more bags from at least one roll of reel.

In accordance with an embodiment of the invention, the present disclosure provides a description of bags to address the perceived need described above, and methods of manufacturing the same.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a perspective to view of a rock bag with a string handle, consistent with disclosed embodiments.

FIG. 2 is a perspective view of a rock bag with a punch out handle, consistent with disclosed embodiments.

FIG. 3 is a perspective view of a rock bag with no handle, consistent with disclosed embodiments.

FIG. 4 is a perspective view of a rock bag with a wave handle, consistent with disclosed embodiments.

FIG. 5A is a perspective view of a rock bag with no handle, consistent with disclosed embodiments.

FIG. 5B is a perspective view from above of a rock bag with no handle being opened, consistent with disclosed embodiments.

FIG. 5C is a perspective view from below of a rock bag with no handle being manipulated, consistent with disclosed embodiments.

FIG. 5D is a perspective side view of a rock bag with no handle having no unintended creases post-manipulation, consistent with disclosed embodiments.

### DESCRIPTION OF THE EMBODIMENTS

Reference will now be made in detail to the present embodiment(s) (exemplary embodiments) of the invention, an example(s) of which is (are) illustrated in the accompanying drawings. Wherever possible, the same reference numbers will be used throughout the drawings to refer to the same or like parts.

A rock bag of the instant disclosure may be understood to contain 50%-80% rock content by weight in most embodiments. In some embodiments a rock bag may more narrowly contain 60%-80% or 70%-80% rock content. However, in some broader embodiments, a rock bag may be characterized as containing 40%-90% or 45%-85% rock contact. It has been observed that bags manufactured from higher levels of rock content lack strength, durability, and/or uniformity. As used herein, rock content may substantially comprise limestone and/or crushed shells (e.g., seashells). However, rock content may additionally or alternatively include other materials with a high proportion of calcium carbonate.

The remaining composition of a rock bag may substantially comprise or consist of plastic. In preferred embodiments, the plastic component may substantially consist of or comprise polyethylene (PE), Polyolefin Elastomers (POE), and/or thermoplastics. In some embodiments HDPE may be preferred over LDPE. Other plastics and plastic blends are contemplated by this disclosure.

In one embodiment, a rock bag may be formed of one (or more) rock-plastic sheet(s) or rock-plastic tube(s). A rock-plastic sheet or tube may be manufactured as follows.

First, crushed rock material, such as crushed limestone or seashell powder may be obtained. The crushed rock material may be formed into pellets. It may be noted that the use of such pellets may beneficially reduce moisture absorption by calcium carbonate during the manufacturing process; in turn, this may permit proportions of rock material substantially higher than the 20-30% included in existing bags.

The pellets may be formed by compounding the crushed rock powder together and kneading it with additives to enable the mixture to be homogenous and easily processable in the next phrase of production. This may ensure that sure the rock powder is blended sufficiently well and evenly. In some embodiments, the additive may substantially consist of or may comprise wax and/or zinc. The wax may serve to lubricate the mixture to, for example, improve the extrusion process. The zinc may serve to, for example, reduce friction during compounding. In certain embodiments the mixture may comprise 1% or less of zinc and/or wax.

The mixture may then be pelletized. In certain embodiments, the pellets may be 2-5 mm diameter in size, or more narrowly 3-5 mm in size.

Next the pellets may be mixed with the plastic material in a co-extruder, a plastic bag film blowing, and/or cast machine. In some embodiments, two or more polymers may be utilized to achieve synergistic effects in the composite product. Colorants may also be added so that the produced rock-plastic sheet or tube, and ultimately the rock bag, may resemble craft and/or white paper. The components may be heated to approximately 180-200 ° C. The co-extruder may mix the plastic and crushed rock components together, dissolving the pellets into the plastic to obtain a uniform rock-plastic mixture. After extrusion/blowing, each rock-plastic sheet/tube may have a preferred thickness of 70-200 um, or more narrowly 70-150 um. The rock-plastic sheet/tube may then be rolled into rolls of reel, which in turn are ready to be formed into bags.

In certain preferred embodiments, each rock-plastic sheet or tube may comprise multiple layers, for example, three layers. The layers may be extruded together to arrive at a sheet/tube that appears substantially uniform. The extruder and/or plastic blowing machine may complete this portion of the process.

In some embodiments, the layers may be of the same thickness, but contain different amounts of rock content. It may be preferred that, for example, the middle layer(s) have a substantially higher rock content. For example, in a three-layer sheet/tube, 10-30% of the total rock material may be in each outer layer and 40%-80% of the total rock material may be in the middle layer. In certain embodiments, 15-25% of the total rock material may be in each outer layer and 50%-70% of the total rock material may be in the middle layer. More narrowly, in some embodiments, 17.5-22.5% of the total rock material may be in each outer layer and 55%-65% of the total rock material may be in the middle layer.

Marking or writing on a rock-plastic sheet, rock-plastic tube, or resulting bag with a pen, marker, pencil, and/or other common writing utensil may be possible but may be difficult in some circumstances due to surface characteristics. In an additional optional step, one or both sides of a rock-plastic sheet/tube may be treated with corona treatment to improve marketability characteristics.

Next, rock bags may be assembled from a rock-plastic sheet(s) or rock-plastic tube in a manner similar to those known in the art for assembling paper or plastic bags. Consistent with plastic bag manufacturing techniques known in the art, a rock bag's seams may be achieved by, for example, gluing, heat sealing, ultrasonic sealing, or even sewing. It may be observed, however, that heat sealing may be less effective at producing durable, strong seals when the plastic content of a rock back is below (or approaches) 20% by weight.

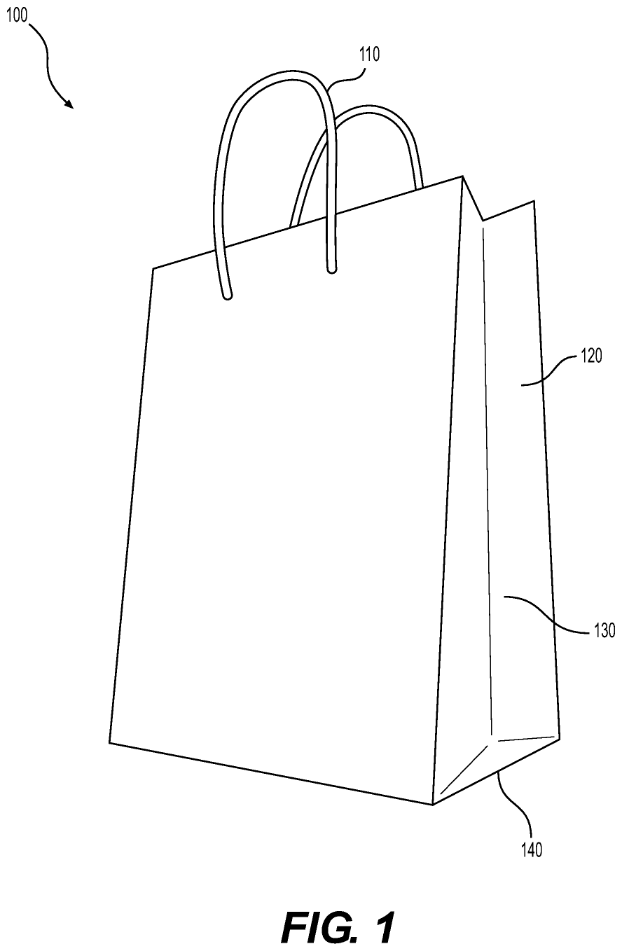

FIGS. 1-4 illustrate various assembled rock bag embodiments.

For example, as shown, a rock bag may have a rectangular or square bottom; may have gusseted sides and/or a gusseted bottom; and/or may have attached and/or punched out handles. The use of other bag elements and/or designs known in the prior art are contemplated.

FIG. 1 shows a bag 100 with an exemplary shape, and an exemplary handle, in this embodiment, string handle 110. The material made from rock is shown for example at arrow 120. The bag is gusseted at 130. The bag bottom 140 is at least partially rectangular.

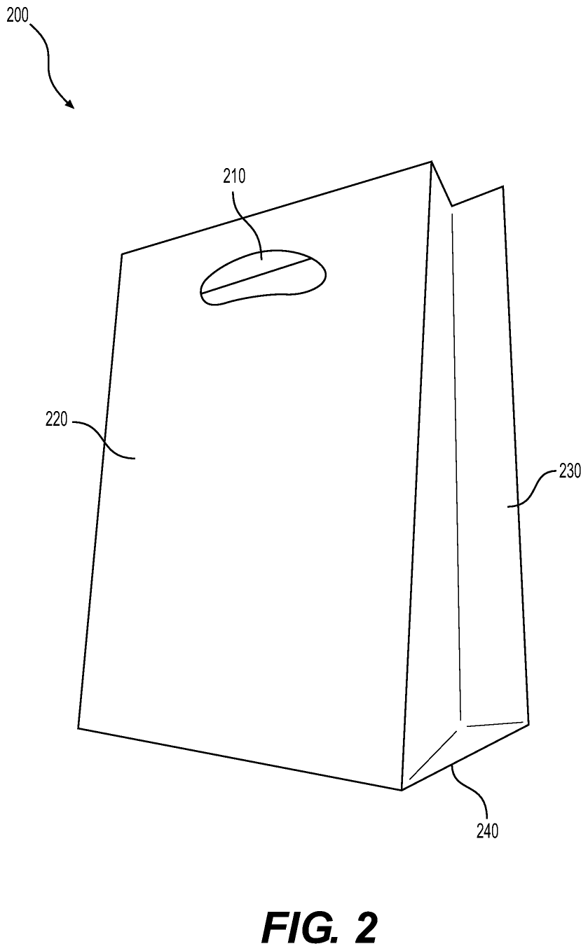

FIG. 2 shows a bag 200 with an exemplary shape, and an exemplary handle, in this embodiment, an extended-oval punched-out handle 210. The material made from rock is shown for example at arrow 220. The bag is gusseted at 230. The bag bottom 240 is at least partially rectangular.

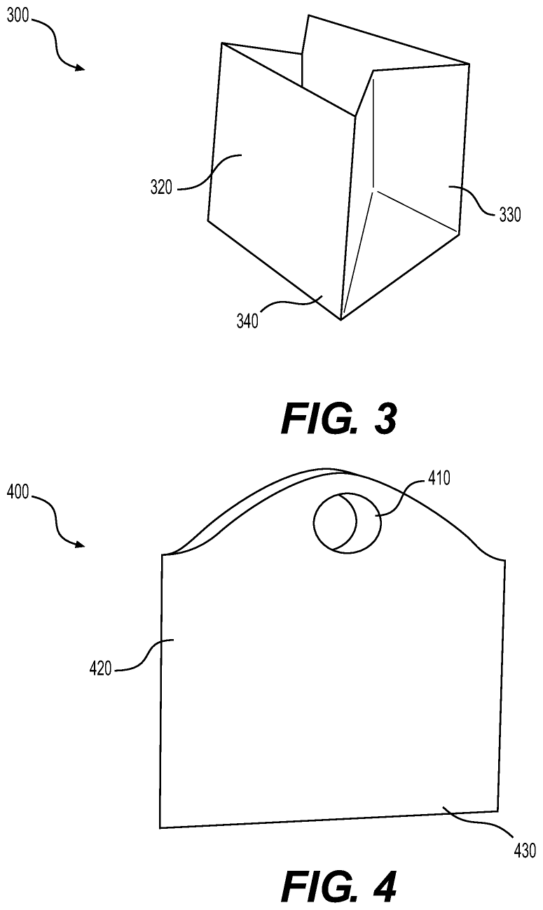

FIG. 3 shows a bag 300 with an exemplary shape, and, in this embodiment, no handle. The material made from rock is shown for example at arrow 320. The bag is gusseted at 330. The bag bottom 340 is at least partially rectangular.

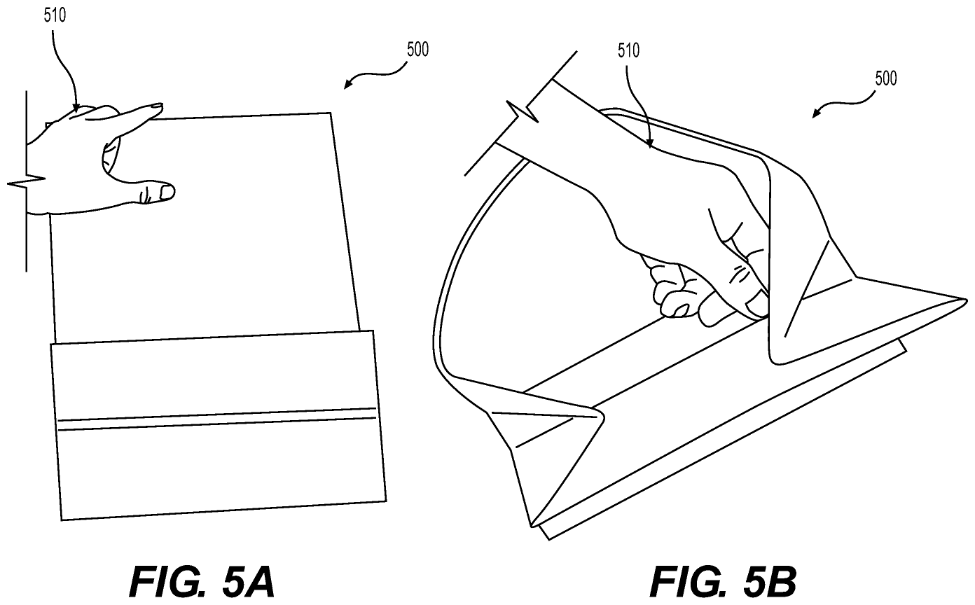

FIG. 4 shows a bag 400 with an exemplary shape, and an exemplary handle, in this embodiment, a round punch-out handle 410. The material made from rock is shown for example at arrow 420. The bag bottom 430 is gusseted and is at least partially rectangular.

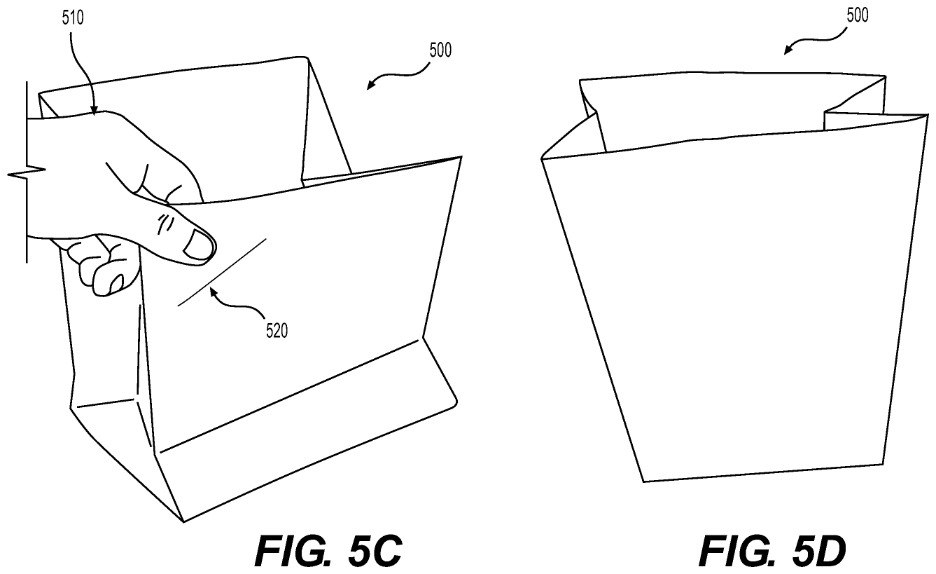

Advantageously, some rock bags consistent with the above-described embodiments have a feel and structural characteristics more similar to paper bags than plastics bags. For example, as may be observed in FIGS. 5A-5D, rock bag material may resemble paper; may have suitable stiffness to easily stand on its own; may be very flexible and still return to its original shape; and may also be folded and creased in a manner similar to paper. A rock bag's resemblance to paper, especially when colorants are included, may be aesthetically pleasing and, accordingly, may beneficially suggest quality or luxury when used as gift bags or shopping bags. FIG. 5A shows rock bag 500 in a folded state. FIG. 5B shows rock bag 500 being opened. FIG. 5C shows rock bag 500 being manipulated, showing for example a crease at 520. FIG. 5D shows a bag in a fully opened state.

Rock bags consistent with the above-described embodiments typically possess strength and durability characteristics that, while slightly inferior to pure plastic bags, are superior to those of paper bags. Rock bags consistent with the above-described embodiments are also, due to their high rock/calcium carbonate content, may be considered photo-degradable, especially when compared to prior art plastic bags.

Although the foregoing embodiments have been described in detail by way of illustration and example for purposes of clarity of understanding, it will be readily apparent to those of ordinary skill in the art in light of the description herein that certain changes and modifications may be made thereto without departing from the spirit or scope of the disclosure. It is also to be understood that the terminology used herein is for the purpose of describing particular aspects only, and is not intended to be limiting, since the scope of the present invention will be limited only by the claims of patent applications claiming priority to the instant disclosure.

It is noted that, as used herein, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only,” and the like in connection with the recitation of claim elements or use of a “negative” limitation. As will be apparent to those of ordinary skill in the art upon reading this disclosure, each of the individual aspects described and illustrated herein has discrete components and features which may be readily separated from or combined with the features of any of the other several aspects without departing from the scope or spirit of the disclosure. Any recited method can be carried out in the order of events recited or in any other order that is logically possible. Accordingly, the preceding merely provides illustrative examples. It will be appreciated that those of ordinary skill in the art will be able to devise various arrangements which, although not explicitly described or shown herein, embody the principles of the disclosure and are included within its spirit and scope.

Furthermore, all examples and conditional language recited herein are principally intended to aid the reader in understanding the principles of the invention and the concepts contributed by the inventors to furthering the art and are to be construed without limitation to such specifically recited examples and conditions. Moreover, all statements herein reciting principles and aspects of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary configurations shown and described herein.

In this specification, various preferred embodiments have been described with reference to the accompanying drawings. It will be apparent, however, that various other modifications and changes may be made thereto, and additional embodiments may be implemented without departing from the broader scope of the disclosure. The specification and drawings are accordingly to be regarded in an illustrative rather than restrictive sense.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A rock bag, comprising:
a first set of opposed sides, each side of which is substantially the same dimensions;
a second set of opposed sides, each side of which is substantially the same dimensions;
a bottom side formed to operatively couple with the first and second set of opposed sides such that the rock bag forms an enclosure with five sides and an opening opposite the bottom side;
wherein the material forming the sides comprises between 40% and 90% rock content.

2. The rock bag of claim 1 wherein the material forming the sides additionally comprises one or more plastic materials.

3. The rock bag of claim 1, wherein the material forming the sides comprises a plurality of layers, each layer having a percentage of rock content distinct from the other layers.

4. The rock bag of claim 1, wherein each side of the first set of opposed sides have one or more mirrored cutouts having substantially the same dimensions near the opening.

5. The rock bag of claim 4, wherein the cutouts are used to attach one or more handles.

6. The rock bag of claim 1, wherein one or more of the sides are gusseted.

7. The rock bag of claim 1 wherein the sides are configured to fold flat.

8. The rock bag of claim 1 wherein at least one external surface has been subjected to corona treatment.

9. A method of manufacturing a rock bag, comprising the following steps:
a) forming crushed rock material into one or more pellets;
b) combining the one or more pellets with additional materials;
c) heating combined materials to approximately 180-200° C.;
d) mixing the heated pellets and the additional materials to obtain a uniform rockplastic mixture;
e) forming rock-plastic mixture into a sheet;
f) repeating steps a-e to obtain multiple sheets that are then rolled into one or more rolls of reel; and
g) forming one or more bags from at least one roll of reel.

10. The method of claim 9, wherein the sheet of step e is immediately formed into a bag instead of being rolled onto a reel and the method ends.

11. The method of claim 9, wherein the additional materials of step b comprise one or more plastic materials.

12. The method of claim 9, wherein the crushed rock material is substantially calcium carbonate.

13. The method of claim 9, wherein step b further comprises combining one or more additives with the combined materials.

14. The method of claim 13, wherein one of the additives is zinc or wax.

15. The method of claim 13, wherein one of the additives is a colorant.

16. The method of claim 9, wherein a corona treatment is applied to at least one external surface of at least one bag.

17. The method of claim 9, wherein the pellets are 2-5 mm in diameter.

18. The method of claim 9, wherein the sheet has a thickness of 70-200 um.

19. The method of claim 9, wherein the rock-plastic mixture is formed into a tube instead of a sheet in step e.

20. The method of claim 19, wherein the tube has a thickness of 70-200 um.
